(19) United States
(12) Patent Application Publication
(10) Pub. No.: US 2007/0262849 A1
(43) Pub. Date: Nov. 15, 2007

(54) Active/Passive Coupled Radio Frequency Identification (RFID) System

(76) Inventor: Amin Rashid Ismail, Orlando, FL (US)

Correspondence Address: RHONDA L. COPLEY, 4700 MILLENIA BLVD., SUITE 175, ORLANDO, FL, 32839, US

(21) Appl. No.: 11/554,775

(22) Filed: Oct. 31, 2006

Related U.S. Application Data
(60) Provisional application No. 60/597,267, filed on Nov. 18, 2005.

(51) Int. Cl. G08B 13/14; H04Q 5/22

(52) U.S. Cl. 340/10.1

(57) ABSTRACT

The present invention discloses an integrated RFID reader (205) that combines active and passive RFID technology to enable automatic identification for any asset equipped with an active or passive RFID tag. The integrated RFID reader uses either a single antenna or dual antennas (225, 230) and two transceivers (210, 215) with a firmware module (220) to read and receive data from both active and passive tags. Similarly, a method for exchanging data between active tags and passive tags is also disclosed (315).

### FIELD OF THE INVENTION

The invention relates generally to radio frequency identification (RFID) system and specifically, to a method and apparatus for reading active and passive RFID tags using a single integrated reader.

### BACKGROUND OF THE INVENTION

Radio Frequency Identification (RFID) systems are of use in many different areas. For example, RFID systems can be used to track goods as they move throughout the supply chain. A typical RFID system comprises an RFID reader, at least one RFID tag affixed to an item of interest and, optionally, a computer system coupled to the RFID reader to process data. Most of the known systems, however, use special RFIDs that are used with corresponding proprietary RFID reader devices. Hence only tags that can communicate with a specific RFID reader can be used and deployed, which proved to be a considerable disadvantage where different types of tags have been deployed in a single environment. For instance, an active tag can only communicate with an RFID reader that can read only its specific active tags.

Passive tags that have been recently introduced, cost less than active tags and require no battery for operation. Since active tags are extremely expensive compared to passive tags, users of RFID systems can not afford to tag all objects and products with active tags; hence they still resort to using conventional methods of identifying, locating and obtaining information of objects like bar codes and manual inventory. Active tags were used only for specific purposes. This increased costs and reduced efficiency considerably. Conventional active RFID readers could only read their active tags while Passive Readers could read only passive tags. Therefore, two separate RFID readers would be necessary for reading both active and passive tags communicating at different frequencies.

Hence, there was a need to create an integrated RFID reader that could communicate with different kinds of tags (for instance, active tags and passive tags) while also facilitating the exchange of data between different kinds of tags.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a block diagram pursuant to an embodiment of the present invention.

FIG. 2 illustrates a system diagram of an integrated RFID reader pursuant to an embodiment of the present invention.

FIG. 3 illustrates a flow diagram of the process followed by the integrated RFID reader pursuant to an embodiment of the present invention.

FIG. 4 illustrates a block diagram of an RFID network pursuant to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to preventing an unauthorized message. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a system to prevent unauthorized messages described herein. The non-processor circuits may include, but are not limited to, a radio receiver, a radio transmitter, signal drivers, clock circuits, power source circuits, and user input devices. As such, these functions may be interpreted as steps of a method to prevent unauthorized messages. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention relates to an apparatus and method of communicating with active tags and passive tags using a single integrated RFID reader. An embodiment of the present invention also relates to an apparatus and method for communicating between active tags thus forming a communications network.

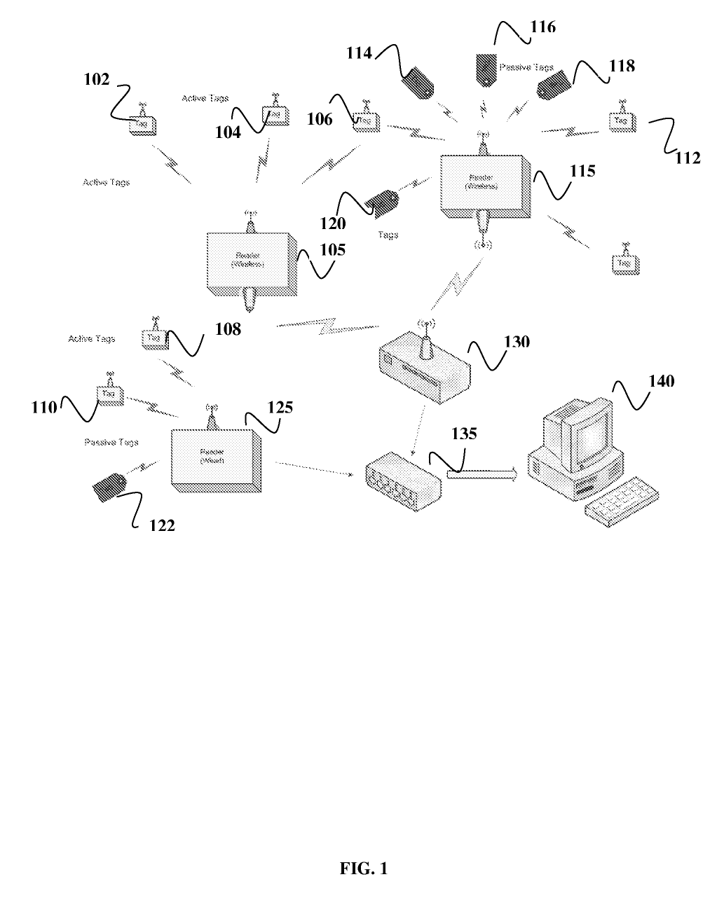

Turning now to FIG. 1, illustrates a block diagram 100 of the environment where an embodiment of the present invention can be deployed. Automatic Identification refers to a host of technologies that are used to help machines identify objects. With the help of this technology, companies, government and individuals can identify objects and personnel (assets) by capturing information about them (generally electronically) and maintaining the data in a memory device for access. The present invention combines an active and passive Radio Frequency Identification (RFID) system to create an integrated RFID reader that combines active and passive RFID to enable automatic identification for any asset equipped with an active or passive RFID tag. Data from Active or passive tags attached to assets, including personnel, are picked up by the integrated RFID. The data can include a tag number, an ID, an EPC, sensor data or any information stored in the memory of the tags or the computer database that is associated with the tag.

As shown in FIG. 1, the integrated RFID reader can be a wireless RFID reader 105, 115 or a wired RFID reader 125. A wireless RFID reader is in communication with a wireless access point 130 via radio frequencies. For instance, wireless protocols such as the 802.11x family of protocols known in the art or a Zigbee (802.15.4) protocol. Other wireless protocols are within the scope of the present invention. However, a wired RFID reader can be in communication via a standard Ethernet connection 135 in the case of a wired infrastructure. There are usually several integrated RFID readers located in a typical installation environment 100, for instance a supermarket, building or warehouse. The basic components in the integrated RFID reader are transceivers, a processor, battery and at least one antenna along with associated electronic components and software to enable circuit operation.

Now, both the wireless and wired integrated RFID readers are in communication with active tags and passive tags. For instance, wireless RFID reader 105 is in communication with active tags 102, 104, 106 and wireless RFID reader 115 is in communication with active tags 106, 112 and passive tags 114, 116, 118 and 120. Similarly, the wired RFID reader is in communication with active tags 108 and 110 and passive tag 122. Passive tags can be at least one of an Electronic Product Code Class 0 compliant tags, Electronic Product Code Class 1 compliant tags, Electronic Product Code Class 1 Generation 2 compliant tags and International Standards Organization compliant tags. Each RFID reader, whether wired or wireless can be in communication with a plurality of tags simultaneously based on an embodiment of the present invention disclosed below.

As known in the art, data can be read from an active tag by interpreting the digital signals being transmitted through radio frequencies from the active tag to the integrated RFID reader, while data from a passive tag is acquired by interrogating the passive tag with an analog signal (waveform) and reading the waveform coming back on the carrier signals. As shown in FIG. 1, data read from both active and passive RFID tags can be stored on the integrated RFID reader memory.

In one embodiment, data collected form the integrated RFID readers in the installation can be sent to a server computing system 140 via wired or wireless infrastructure. For instance in the case of a supermarket, all data received from products on the shelves of the supermarket, such as number of products remaining, the expiration data of the products, number of products sold can be send to the manager of the supermarket by the integrated RFID reader/readers. Since passive tags and active tags serve different purposes, a supermarket may comprise both active and passive tags. By deploying the integrated RFID reader, a supermarket can get information from both kinds of tags simultaneously. For example, carts could be tagged with active tags while products could be tagged with passive tags so the manager could see the movement of the carts through the aisles and the goods selected to evaluate the shopping habits of the customers. Deploying active tags on each product can be extremely expensive and hence a combination of active tags and passive tags serving different purposes with a single integrated RFID reader can considerably reduce costs and provide an efficient system. Data flow is bi-directional between the integrated RFID reader and the server computing system 140 via the network connection. When data in updated on the server computing system 140, new or updated information can be written from the server computing system 140 through the integrated RFID reader to the active and passive tags. Since active tags have more memory, can incorporate onboard sensors and can stream out data, active tags can be used for many more purposes than passive tags generally used for product identification. Active tags can monitor personnel or visitor movement, sensor variance on moving assets and can transmit the data longer distances. They can show movement of vehicles and personnel within indoor or outdoor environments.

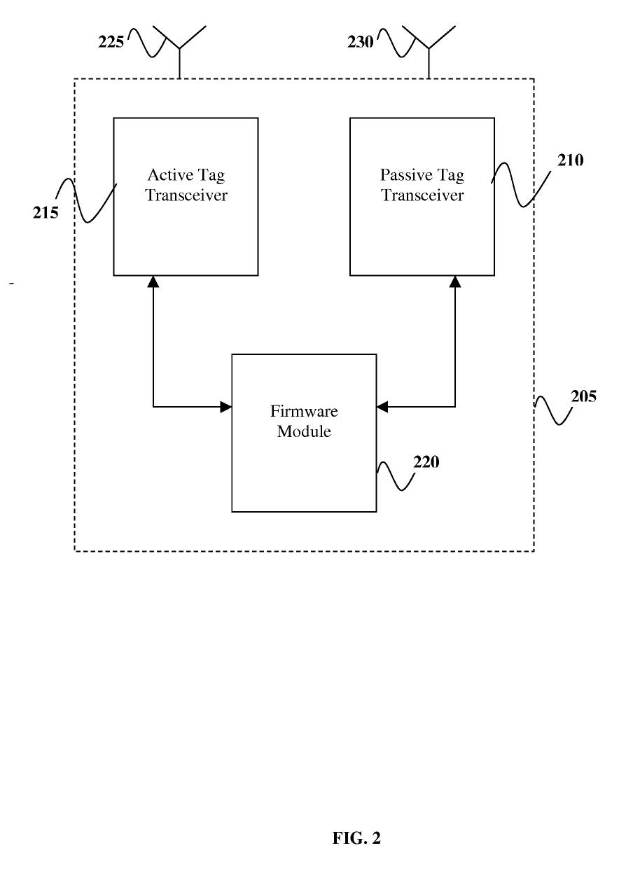

Referring now to FIG. 2, that illustrates a system diagram of an integrated RFID reader pursuant to an embodiment of the present invention. The integrated RFID reader can be used to communicate with active and passive tags simultaneously or sequentially. As per one embodiment, the integrated RFID reader comprises a first transceiver, for instance an active tag transceiver 215 for communicating with active tags and second transceiver, for instance a passive tag transceiver 210 for communicating with a passive tag.

The active tag transceiver 215 and the passive tag transceiver 210 are operatively coupled to their respective antennas 225, 230. The two transceivers can communicate at different or substantially equal frequencies. Tags may be developed using a frequency according to the needs of the system including read range and the environment in which the tag will be read. Generally, the integrated RFID reader can support high frequency 13.56 MHz, Ultra high frequency between 868 MHz and 960 MHz and 2.45 GHz active Tags. In another embodiment, the integrated RFID reader may also be equipped with a single antenna coupled with a switching circuitry to change frequencies for communication with active tags and passive tags.

When the integrated RFID reader 205 is powered on, the firmware module 220 is configured to initialize all passive transceiver registers and active transceiver registers to default power levels. All external communication interfaces for communication with devices communicating using different protocols, for instance asynchronous serial RS232/TTL, 802.1x families of wireless protocols, Bluetooth devices, Zigbee capable devices are also initialized. The firmware module 220 on the integrated RFID reader 205 then scans input communications data stream for an application programming interface (API) command. Now the integrated RFID reader has been initialized to read active and passive tags using the various external interfaces.

In one embodiment, while reading an active tag, the integrated RFID reader disables the passive transceiver 210 and enables the active transceiver 215. The integrated RFID reader broadcasts a beacon informing the active tags to respond and send data. The integrated RFID reader 205 waits for active tag responses. While receiving data from an active tag, the firmware module 220 builds active tag identification and sensor data packets and starts interpreting the data received from the active tag. Data received from an active tag can be in a first format, which is generally different from the data format stored on the passive tag.

Similarly, while reading a passive tag, the integrated RFID reader disables the active transceiver 215 and enables the passive transceiver 210. The integrated RFID reader broadcasts a signal informing the passive tags to respond and send data. However, as opposed to active tags that are powered using their own batteries, passive tags only communicate when the integrated RFID reader 205 sends a signal to the passive tag which is powered on receiving the signal. The passive tag uses the same carrier signal to send data to the integrated RFID reader. The integrated RFID reader 205 waits for passive tag responses. While receiving data from a passive tag, the firmware module 220 similarly builds passive tag identification and sensor data packets and starts interpreting the data received from the passive tag. Once the integrated RFID reader has completed reading data from active and passive tags, the firmware 220 instructs the active transceiver 215 and the passive transceiver 210 to shutdown temporarily to conserve battery.

Hence, the integrated RFID reader is able to communicate with both active and passive tags using the transceivers and associated antennas. Data received from an active tag can be forwarded and stored on another active tag or even after conversion at the integrated RFID reader stored on passive tags. Similarly, passive tag data can be appended onto active tag data and stored on another active tag via the integrated RFID reader. Such a setup may be useful in logistics applications. For instance, shipping crates can be equipped with an integrated RFID reader during loading so that when active and passive tagged items are being placed in the crate they are automatically read by the integrated RFID reader. Once items have been stocked in a shipping crate the integrated RFID reader can write the contents to an active tag and adhere it to the crate. Since the integrated RFID reader can read data from an active tag and forward the data to another active tag. In one embodiment, the RFID reader can even read data from a passive tag, convert the data to an active tag compliant format data and transmit the data to an active tag. That active tag can then be read during transit so the contents of the crate can be known without having to access the manifest database (all passive tags). Additionally, the tag can forward information to other tags around the warehouse, ship or loading area so there is an up-to-the-minute inventory management system. Forwarding and storing of data between tags and the ability to read both passive and active tags simultaneously provides an increased advantage over conventional methods. The efficiency of such installations, for example in airports, supermarkets, hotels and other industries is also greatly increased.

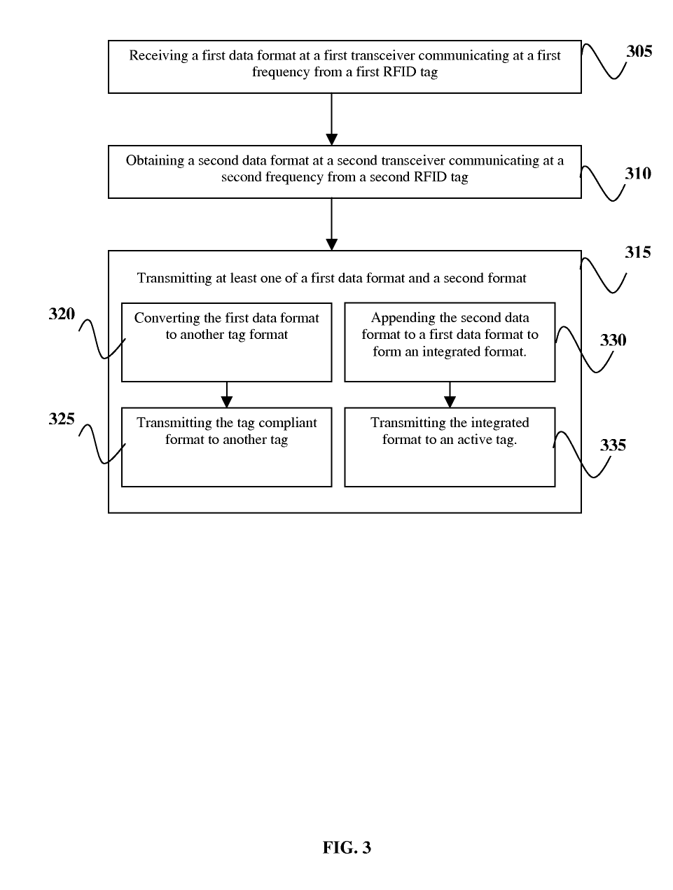

According to an embodiment, as illustrated in a flow diagram in FIG. 3, a method of exchanging data between a plurality of RFID tags using an RFID integrated reader is disclosed. The RFID technology combines active and passive radio frequencies to automatically identify any asset equipped with an active or passive RFID tag. The information such as a tag number, a unique identification, sensor data or any other information stored in the memory of an active or a passive tag or a computing device associated with the tag, is detected by the integrated active and passive reader illustrated in FIG. 2.

Turning to FIG. 3, the integrated RFID reader comprises initially receiving a first data format at a first transceiver, step 205. A first data format may, for instance be the format of data received from an active tag. Alternatively, the first data format can also be the format of data received while interrogating a passive tag. As per an embodiment of the present invention, the first transceiver of the integrated RFID reader can be operatively coupled to a first antenna for communicating at a first frequency with the active or passive tags. For example, the first antenna can be an antenna communicating at any one of a high frequency substantially equal to 13.56 MHz, an ultra high frequency in a 900 Mhz band and 2.45 Ghz band for communicating with active tags. Those skilled in the art shall appreciate that communication at any frequency is possible and these frequencies represent some of the standard frequencies used for communication with active tags. The data received by the integrated RFID reader is read from the active tag by the firmware module interpreting digital signals transmitted through radio frequencies from the active tag to the reader. The integrated reader can communicate with several active tags simultaneously and receive data from several active tags which can be read by the firmware module and displayed to a user of the integrated RFID reader.

Similarly, the integrated RFID reader can receive a second data format at a second transceiver that can be operatively coupled to a second antenna from a second RFID tag, step 310. The second RFID tag can be for instance, a passive RFID tag that communicates with the integrated RFID reader at a second frequency. The data is read from the passive tag by interrogating the passive tag with an analog waveform and interpreting the waveform coming back to the integrated RFID reader on the carrier signals. Frequencies used to communicate with a passive tag are known in the art and all such frequencies are within the scope of present invention. In one embodiment, the first frequency can be substantially equal to the second frequency. In another embodiment, an integrated switching circuit can be used with a single antenna and a transceiver may switch between frequencies while communicating with both active tags and passive tags.

The integrated RFID reader can transmit the data received from the active tag or passive tag to the same or another active tag or passive tag, step 315. For instance, if the user wishes to receive data from a passive tag and store the data on an active tag, the integrated RFID reader can serve as a means to receive the data, convert the data to an active tag compliant format and transmit the data to the active tag, step 320, 325. Similarly, information from an active tag can be stored on other active tags and read by the integrated RFID reader or by a conventional active tag reader. Hence, the active tag can subsequently be physically relocated and read by another integrated RFID reader or simply a conventional active tag reader capable of interpreting the active tag data format. In this way, information can be stored and forwarded around a system. For example, shipping consignments of medical supplies can be equipped with a plurality of active tags while being transported. Prior to shipping, a worker may use the integrated RFID reader to read individual passive tags on syringes or drug bottles as they are being packed into boxes or shipping crates. The data read can then be written to or stored on an active tag adhered to the shipment. When the shipment reaches a different port or destination, the data from the active tag containing the crate's contents can be read using an RFID reader or forwarded to other active tags at the destination so the contents can added to the shipping consignment. The integrated RFID reader and the active tags themselves can serve as a means to forward data at the destination to active tags on the ship or transport vehicle. Similarly, other active tags can be updated with data received from an active tag.

In another embodiment, the integrated RFID reader can read data in the first format from an active tag and read data in the second format from a passive tag either simultaneously or sequentially. Since both the formats can be different, the firmware module on the integrated RFID reader can append the second data format on the first data format to create an integrated data format, step 330. Those skilled in the art shall appreciate that the second data format received from the passive tag can also be converted to an active tag compliant format. However, where conversion may consume substantial resources, the second data format may be simply appended with the first format data received from the active tag and transmitted to another active tag, step 335. This provides an advantage where data from a passive tag can also be stored on an active tag via the integrated RFID reader.

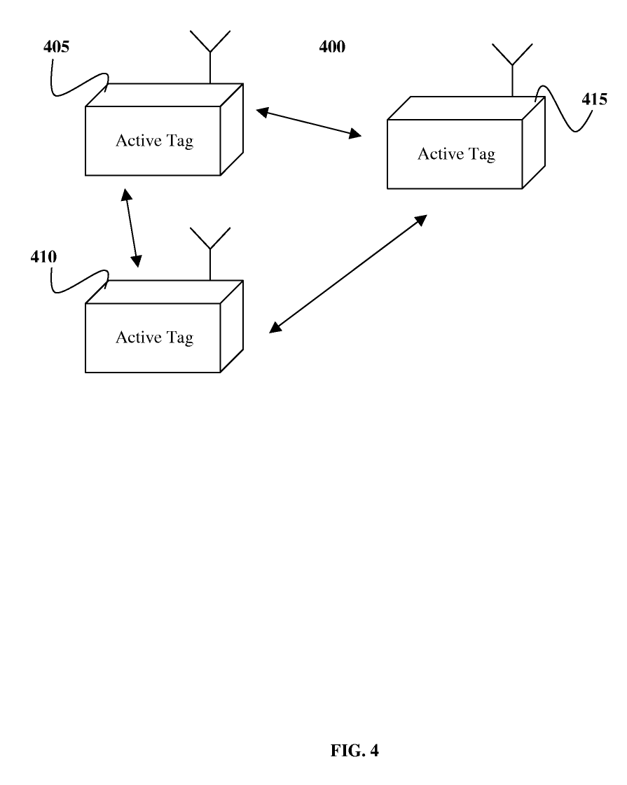

Referring now to FIG. 4 that shows a block diagram of an RFID network 400 pursuant to an embodiment of the present invention. Active tag 405, active tag 410 and active tag 415 are in communication with one another. Each active tag comprises basic components such as a transceiver, processor, battery and antenna along with associated electronic components to enable circuit operation. The active tags can communicate at a predefined frequency, for instance the Ultra-high frequency (UHF) band to send and receive data. While communicating, the active tags can form an ad-hoc network where data can be exchanged or relayed between the active tags. For example, a manager of a supermarket may update an active tag that is within communication range of the integrated RFID reader with inventory information. The active tag can then update all other active tags by communicating with different active tags within its communication range. Even though the tags may not be within range of the RFID reader they can communicate their unique identification, time stamp and say sensor values, such as temperature, by communication with other tags within their proximity. This reduces the need to update each tag individually. Similarly, data such as expiration date or nutritional contents can also be forwarded to other active tags forming part of the ad-hoc network. Since active tags are built with much of the same functionality and capability as the integrated RFID reader (without the passive tag functionality), the active tags and readers can be interchanged and serve both purposes of reading and forwarding data.

What is claimed is:

1. An integrated RFID reader comprising:
a first transceiver operatively coupled to a first antenna for communicating at a first frequency;
a second transceiver operatively coupled to a second antenna for communicating at a second frequency; and
a firmware module in communication with the first transceiver and the second transceiver for analyzing data acquired by the first transceiver and the second transceiver.

2. The integrated RFID reader of claim 1, wherein the first frequency can be substantially equal to the second frequency.

3. The integrated RIFD reader of claim 1, wherein the integrated RFID reader is configured to receive a first data format from an active tag, the active tag communicating at the first frequency.

4. The integrated RFID reader of claim 3, wherein the first data format received from the first active tag can be exchanged with a second active tag via the integrated RFID reader.

5. The integrated RFID reader of claim 3, wherein the first data format received from the first active tag can be exchanged with a passive tag via the integrated RFID reader.

6. The integrated RFID reader of claim 3, wherein the first data format received from the first active tag can be appended with a second data format received from a passive tag by the integrated RFID reader and sent to the first active tag.

7. The integrated RFID reader of claim 3, wherein the first frequency is at least one of a high frequency substantially equal to 13.56 MHz, an ultra high frequency in a 900 Mhz band and a frequency in the 2.4 Ghz band.

8. The integrated RIFD reader of claim 1, wherein the integrated RFID reader is configured to receive a second data format from a passive tag, the passive tag communicating at the second frequency.

9. The integrated RFID reader of claim 8, wherein the passive tags can be at least one of an Electronic Product Code Class 0 compliant tags, Electronic Product Code Class 1 compliant tags, Electronic Product Code Class 1 Generation 2 compliant tags and International Standards Organization compliant tags.

10. The integrated RFID reader of claim 1, wherein the integrated RFID reader is connected to a computing device via a wired or wireless communication interface to store data acquired by the first transceiver and the second transceiver.

11. A method of exchanging data between a plurality of RFID tags using an integrated RFID reader, the method comprising:
receiving a first data format at a first transceiver communicating at a first frequency from a first RFID tag, the first RFID tag being a part of the plurality of RFID tags, the first transceiver being operatively coupled to a first antenna;
obtaining a second data format at a second transceiver communicating at a second frequency from a second RFID tag, the second RFID tag being a part of the plurality of RFID tags, the second transceiver being operatively coupled to a second antenna;
transmitting at least one of a first data format and a second data format based on a predetermined set of parameters.

12. The method of claim 11, wherein the transmitting step further comprises:
converting the first data format to a passive tag compliant format if the first data format is in an active tag compliant format; and
transmitting the passive tag compliant format to a passive tag.

13. The method of claim 11, wherein the transmitting step further comprises:
appending the second data format to the first data format to form an integrated format if the first data format is in an active tag compliant format and the second data format is in a passive tag compliant format; and
transmitting the integrated format to an active tag.

14. The method of claim 11, wherein the first data format is transmitted via wired or wireless interfaces.

15. The method of claim 11, wherein the first RFID tag is an active tag.

16. The method of claim 11, wherein the second RFID tag is a passive tag.

17. An RFID tag network comprising:
a first RFID tag comprising a first transceiver operatively coupled to a first antenna for communicating at a first frequency;
a second RFID tag comprising a second transceiver operatively coupled to a second antenna for communicating at the first frequency; and
a first RFID tag firmware module at the first RFID tag and a second RFID tag firmware module at the second RFD tag to exchange data between the first RFID tag and the second RFID tag, the first RFID tag firmware module being in communication with the first transceiver and the second RFID tag firmware module being in communication with the second transceiver.

18. The RFID tag network of claim 17, where the first RFID tag and the second RFID tag are active tags.
